(19) United States
(12) Patent Application Publication
(10) Pub. No.: US 2024/0170890 A1
(43) Pub. Date: May 23, 2024

(54) CONNECTOR DEVICE

(71) Applicant: JAPAN AVIATION ELECTRONICS INDUSTRY, LIMITED, Shibuya-ku, Tokyo (JP)

(72) Inventors: Kenya HIRASHIMA, Tokyo (JP); Yuichiro NAKAMURA, Tokyo (JP); Yuji KAMEI, Tokyo (JP)

(73) Assignee: JAPAN AVIATION ELECTRONICS INDUSTRY, LIMITED, Shibuya-ku, Tokyo (JP)

(21) Appl. No.: 18/380,840

(22) Filed: Oct. 17, 2023

(30) Foreign Application Priority Data
Nov. 17, 2022 (JP) 2022-184369

(51) Int. Cl. H01R 13/629

(52) U.S. Cl. CPC H01R 13/62938; H01R 2201/26

(57) ABSTRACT

A connector device comprises a connector and a mating connector. The connector and the mating connector are mateable with each other. The connector comprises a housing and a terminal. The housing is provided with an axis portion and a maintenance portion. The mating connector comprises a mating housing and a mating terminal. The mating housing is provided with a mating axis portion and a mating maintenance portion. One of the axis portion and the mating axis portion is a rotation axis with an axis direction. A remaining one of the axis portion and the mating axis portion is a bearing. The connector is rotatable around the rotation axis between an open position and a close position when the axis portion and the mating axis portion are combined with each other. The maintenance portion and the mating maintenance portion temporarily maintain a position of the connector at the open position.

### CROSS REFERENCE TO RELATED APPLICATIONS

This application is based on and claims priority under 35 U.S.C. § 119 to Japanese Patent Application No. JP2022-184369 filed Nov. 17, 2022, the contents of which are incorporated herein in their entirety by reference.

### BACKGROUND OF THE INVENTION

This invention relates to a connector device which is attached to, for example, an electric car or hybrid car, and which relays electrical power, which is supplied from a power supply system, thereto.

A connector device of this type is disclosed in, for example, JPA2022-102010 (Patent Document 1)

As shown in FIGS. 31 and 32, Patent Document 1 discloses a connector device 900 comprising a connector 920 and a mating connector 960. The connector 920 and the mating connector 960 are mateable with each other. The connector 920 comprises a housing 922 and a terminal 924, or a power supply terminal 924. The housing 922 holds the power supply terminal 924. The housing 922 is provided with axis portions 9222, or bearings 9222, and guide portions 9224, or guide ditches 9224. The mating connector 960 comprises a mating housing 962 and mating terminals 964, or mating power supply terminals 964. The mating housing 962 holds the mating power supply terminals 964. The mating housing 962 is provided with mating axis portions 9622, or rotation axes 9622, and mating guide portions 9624, or guide protrusions 9624. When each of the bearings 9222 and a corresponding one of the rotation axes 9622 are combined with each other, the connector 920 is rotatable about the rotation axis 9622 between an open position, which is shown in FIG. 31, and a close position which is not shown. The guide ditches 9224 receive the guide protrusions 9624, respectively, to guide a rotational movement of the connector 920. When the connector 920 is positioned at the open position, the power supply terminal 924 is not connected with any of the mating power supply terminals 964. When the connector 920 is positioned at the close position, the power supply terminal 924 is connected with both the mating power supply terminals 964. When the connector 920 is positioned at the open position, the connector 920 is separable from the mating connector 960 by the connector 920 being moved toward a positive Z-direction, or upward, in a Z-direction, or in an up-down direction.

### SUMMARY OF THE INVENTION

It is an object of the present invention to provide a connector device which can avoid, in advance, a problem that is caused by a space, in which the connector device is actually mounted, and that may adversely affect an operability of the connector device mounted in the space.

Considering a space in which a connector device such as the connector device 900 of Patent Document 1 is mounted, a part of a connector, which is held by an operator upon a rotation of the connector from a close position to an open position, and a part of the connector, which is held by the operator upon a separation of the connector at the open position from a mating connector, might be different from each other during a separation process in which the connector is separated from the mating connector after the connector is rotated from the close position to the open position. In other words, the operator might change a manner, in which the operator holds the connector, during an interval prior to an operation of separating the connector from the mating connector after the connector is rotated from the close position to the open position. This means that, during the separation process, the connector at the open position might be temporarily in a state where the connector is not held by the operator. Accordingly, the connector at the open position might be unintentionally rotated by its own weight from the open position toward the close position during the separation process.

If the connector at the open position is unintentionally rotated to the close position during the separation process, the operator must rotate the connector to the open position again in order to achieve the separation of the connector from the mating connector. Specifically, if the connector at the open position is unintentionally rotated to the close position in the connector device such as the connector device 900 of Patent Document 1, an operation of separating the connector from the mating connector becomes complicated. Additionally, when the connector at the open position is unintentionally rotated to the close position, the connector might abut against the mating connector and thereby a part of the connector might be broken. Thus, the connector device is required to have a mechanism which enables the connector to temporarily stand at the open position even when the connector is not held by the operator.

One aspect of the present invention provides a connector device comprising a connector and a mating connector. The connector and the mating connector are mateable with each other. The connector comprises a housing and a terminal. The housing holds the terminal. The housing is provided with an axis portion and a maintenance portion. The mating connector comprises a mating housing and a mating terminal. The mating housing holds the mating terminal. The mating housing is provided with a mating axis portion and a mating maintenance portion. One of the axis portion and the mating axis portion is a rotation axis with an axis direction. A remaining one of the axis portion and the mating axis portion is a bearing. The connector is rotatable around the rotation axis between an open position and a close position when the axis portion and the mating axis portion are combined with each other. The terminal is not connected with the mating terminal when the connector is positioned at the open position. The terminal is connected with the mating terminal when the connector is positioned at the close position. The maintenance portion and the mating maintenance portion temporarily maintain a position of the connector at the open position.

The connector device of the present invention is configured so that the maintenance portion of the connector and the mating maintenance portion of the mating connector temporarily maintain the position of the connector at the open position. Accordingly, in the connector device of the present invention, the connector can temporarily stand at the open position even when the connector is not held by the operator. In other words, the connector device of the present invention avoids, in advance, a problem that is caused by a space, in which the connector device is actually mounted, and that may adversely affect an operability of the connector device mounted in the space.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a side view showing a connector device according to an embodiment of the present invention. In the figure, a connector is positioned at an open position, and the connector and a mating connector are in an unmated state where the connector and the mating connector are unmated with each other.

FIG. 2 is a top view showing the connector device of FIG. 1.

FIG. 3 is a cross-sectional view showing the connector device of FIG. 2, taken along line A-A.

FIG. 4 is a cross-sectional view showing the connector device of FIG. 2, taken along line B-B.

FIG. 5 is another side view showing the connector device of FIG. 1. In the figure, the connector is positioned at a close position, and the connector and the mating connector are in a mated state where the connector and the mating connector are mated with each other.

FIG. 6 is a top view showing the connector device of FIG. 5.

FIG. 7 is a cross-sectional view showing the connector device of FIG. 6, taken along line C-C.

FIG. 8 is a cross-sectional view showing the connector device of FIG. 6, taken along line D-D.

FIG. 9 is a side view showing the connector which is included in the connector device of FIG. 5.

FIG. 10 is a perspective view showing the connector of FIG. 9.

FIG. 11 is a bottom view showing the connector of FIG. 9.

FIG. 12 is a rear view showing the connector of FIG. 9.

FIG. 13 is another side view showing the connector of FIG. 9.

FIG. 14 is a side view showing the mating connector which is included in the connector device of FIG. 5.

FIG. 15 is a perspective view showing the mating connector of FIG. 14.

FIG. 16 is a top view showing the connector of FIG. 14.

FIG. 17 is a top view showing a first modification of the connector device of FIG. 1. In the figure, a connector is positioned at an open position, and the connector and a mating connector are in an unmated state where the connector and the mating connector are unmated with each other.

FIG. 18 is a cross-sectional view showing the connector device of FIG. 17, taken along line E-E.

FIG. 19 is another top view showing the connector device of FIG. 17. In the figure, the connector is positioned at a close position, and the connector and the mating connector are in a mated state where the connector and the mating connector are mated with each other.

FIG. 20 is a cross-sectional view showing the connector device of FIG. 19, taken along line F-F.

FIG. 21 is a side view showing the connector which is included in the connector device of FIG. 19.

FIG. 22 is a perspective view showing the connector of FIG. 21.

FIG. 23 is a rear view showing the connector of FIG. 21.

FIG. 24 is a top view showing a second modification of the connector device of FIG. 1. In the figure, a connector is positioned at an open position, and the connector and a mating connector are in an unmated state where the connector and the mating connector are unmated with each other.

FIG. 25 is a cross-sectional view showing the connector device of FIG. 24, taken along line G-G.

FIG. 26 is another top view showing the connector device of FIG. 24. In the figure, the connector is positioned at a close position, and the connector and the mating connector are in a mated state where the connector and the mating connector are mated with each other.

FIG. 27 is a cross-sectional view showing the connector device of FIG. 26, taken along line H-H.

FIG. 28 is a side view showing the connector which is included in the connector device of FIG. 26.

FIG. 29 is a perspective view showing the connector of FIG. 28.

FIG. 30 is a rear view showing the connector of FIG. 28.

FIG. 31 is a side view showing a connector device of Patent Document 1.

FIG. 32 is a cross-sectional view showing the connector device of FIG. 31.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

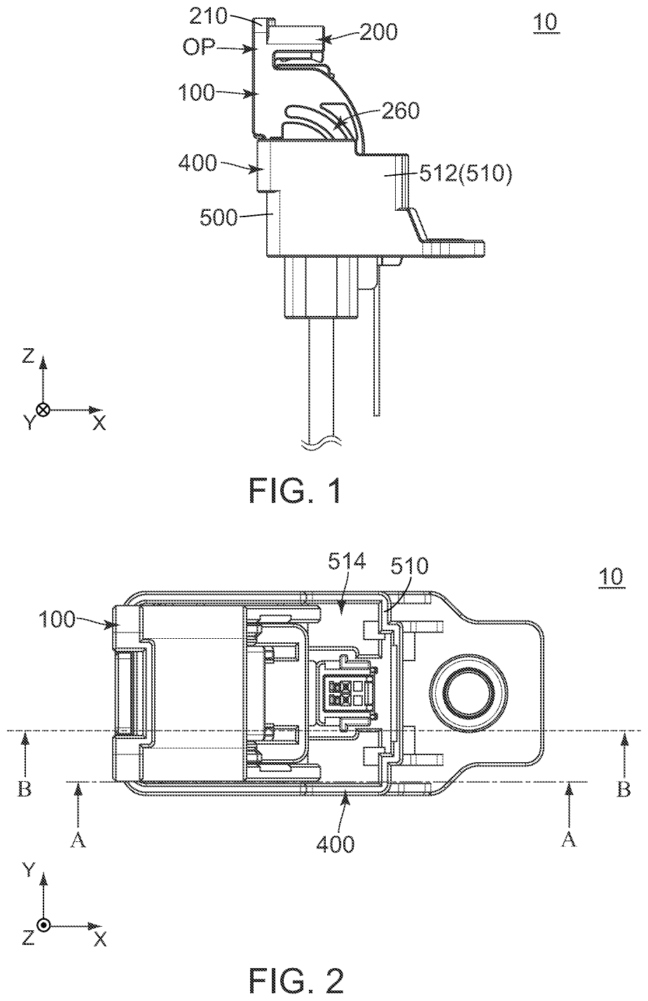

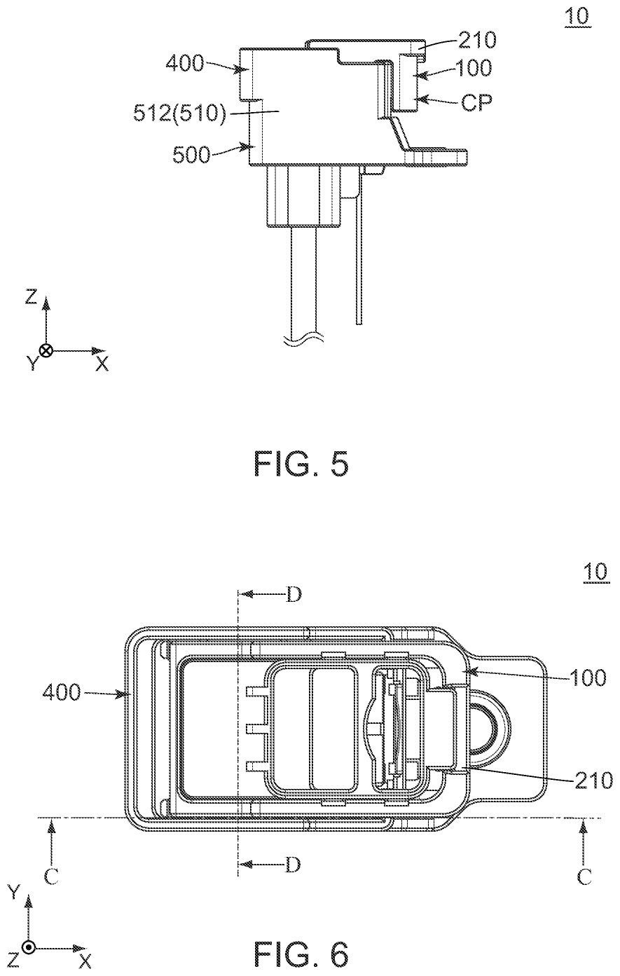

As shown in FIG. 1, a connector device 10 according to an embodiment of the present invention comprises a connector 100 and a mating connector 400. Referring to FIGS. 1 and 5, the connector 100 and the mating connector 400 are mateable with each other.

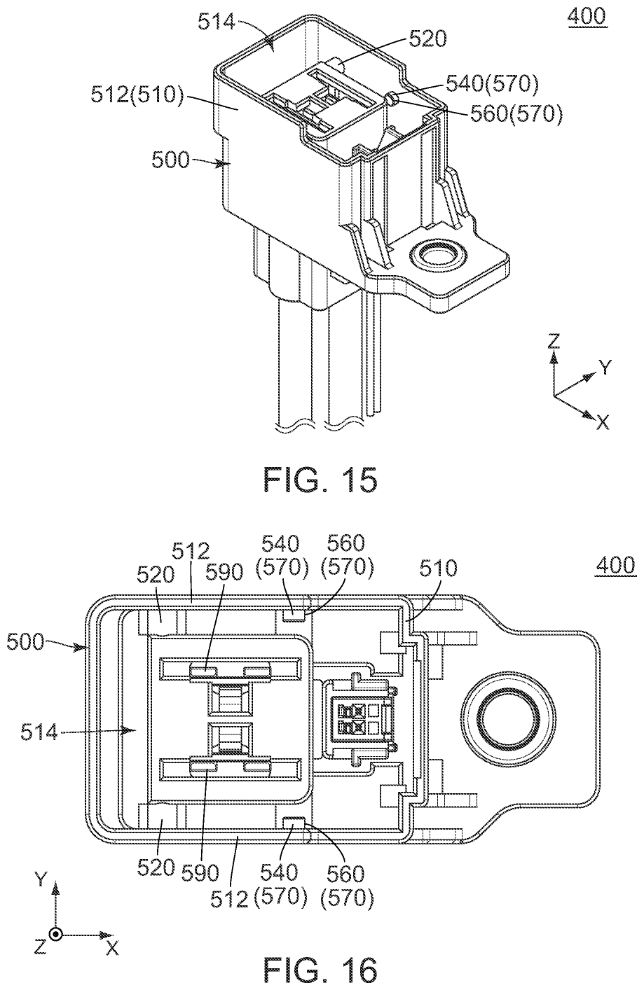

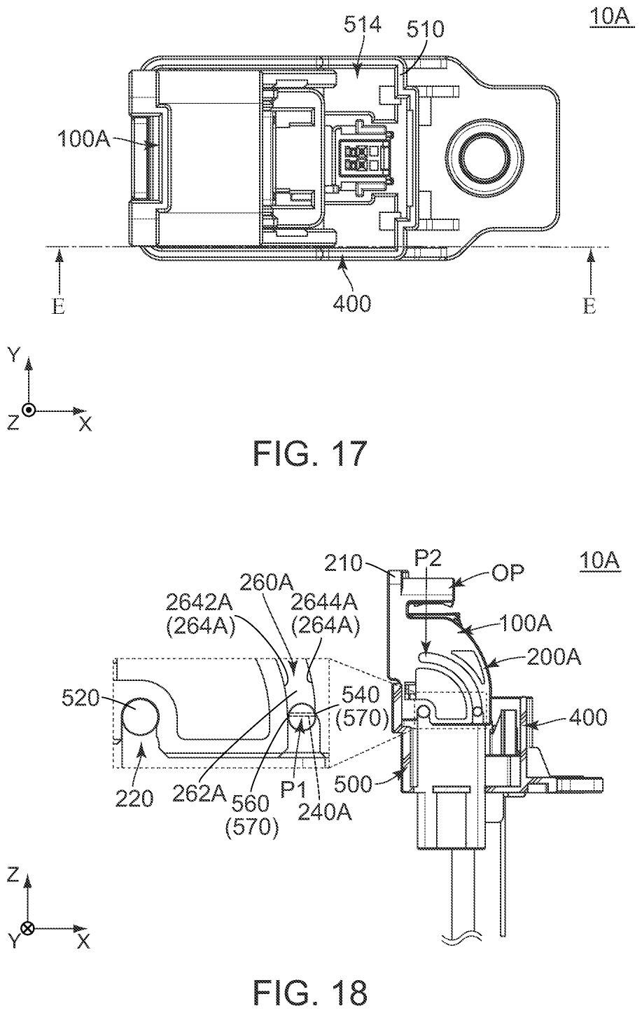

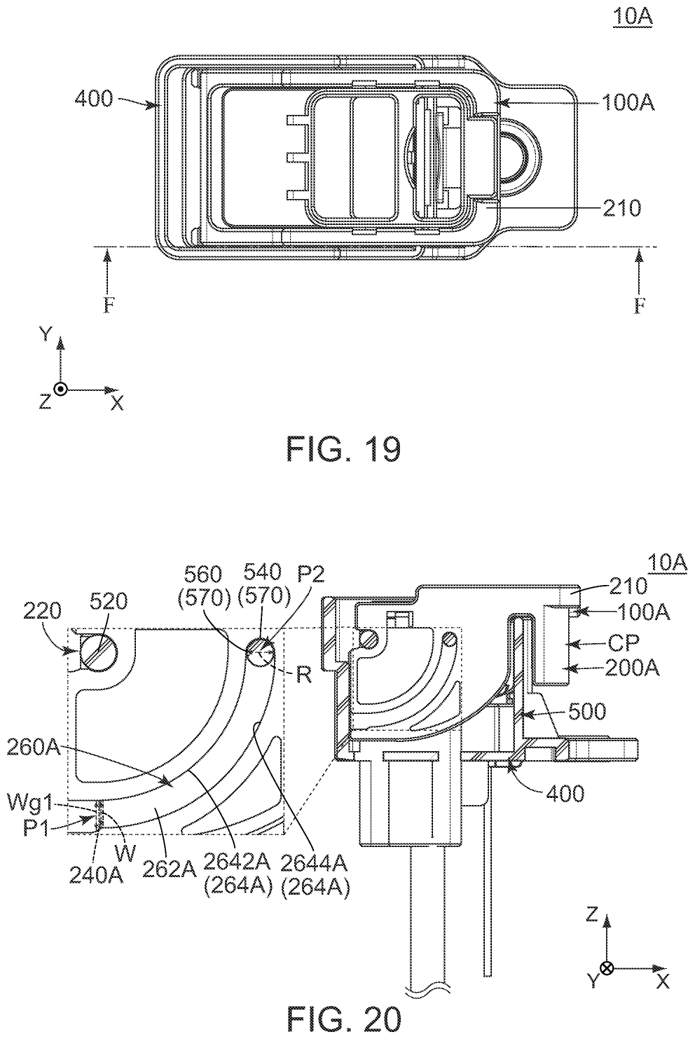

Referring to FIG. 15, the mating connector 400 of the present embodiment is configured to be mounted on an object (not shown) such as an electric car. In addition, the mating connector 400 is configured to be connected with both a power supply system (not shown) and a motor (not shown). Referring to FIG. 5, the connector device provides electrical continuity between the power supply system and the motor under a mated state shown in FIG. 5. As a result, a large current such as about 100A, which is supplied by the power supply system, is supplied to the motor through the connector device 10. However, the present invention is not limited thereto, but the present invention is applicable to many variations of the connector device 10.

As shown in FIG. 16, the mating connector 400 of the present embodiment comprises a mating housing 500 and mating terminals 590.

As shown in FIG. 16, the mating housing 500 of the present embodiment holds the mating terminals 590. The mating housing 500 has a surrounding portion 510 and a receiving portion 514.

As shown in FIG. 15, the surrounding portion 510 of the present embodiment has a substantially rectangular tube shape extending in an up-down direction. In the present embodiment, the up-down direction is a Z-direction. Specifically, it is assumed that upward is a positive Z-direction while downward is a negative Z-direction. The surrounding portion 510 has two side walls 512.

As shown in FIG. 16, the side walls 512 of the present embodiment define opposite ends, respectively, of the mating housing 500 in a width direction. Each of the side walls 512 has a plate-like shape perpendicular to the width direction. In the present embodiment, the width direction is a Y-direction.

As shown in FIG. 16, the receiving portion 514 of the present embodiment is a space which is surrounded by the surrounding portion 510. In other words, the receiving portion 514 is surrounded by the surrounding portion 510 in a plane perpendicular to the up-down direction. The receiving portion 514 is opened upward in the up-down direction.

As shown in FIG. 16, the mating housing 500 is provided with two mating axis portions 520 and two mating maintenance portions 540.

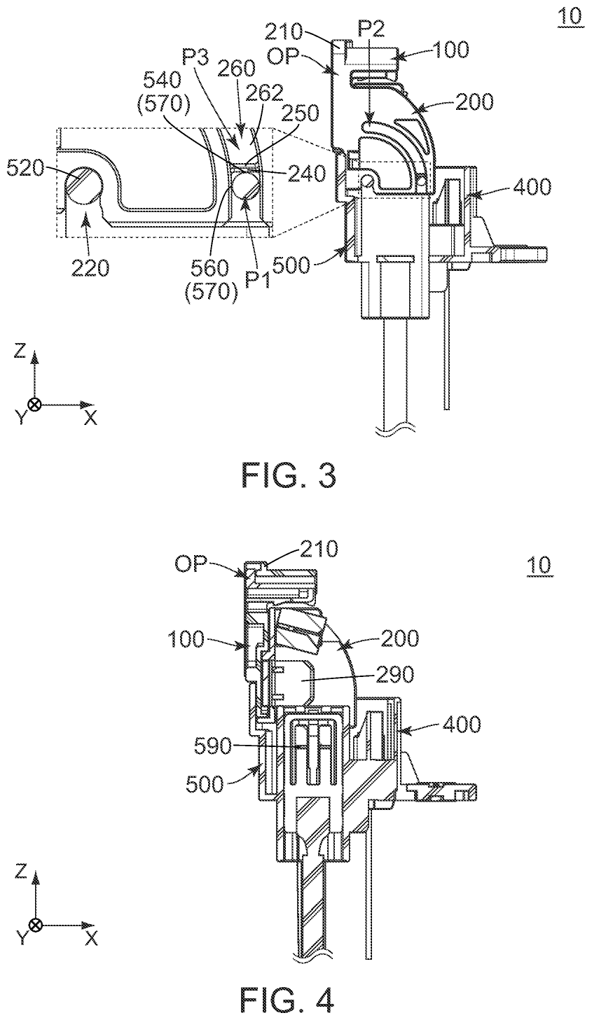

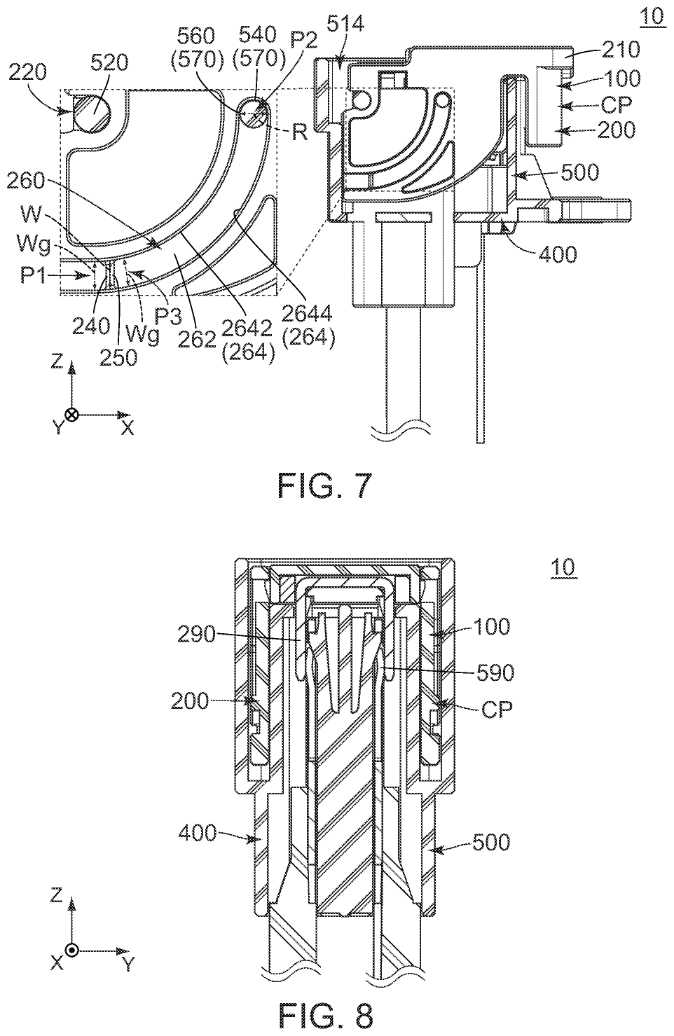

As shown in FIG. 16, each of the mating axis portions 520 of the present embodiment is positioned in the receiving portion 514. The mating axis portions 520 are provided so as to correspond to the two side walls 512, respectively. Each of the mating axis portions 520 extends inward in the width direction from the corresponding side wall 512. Each of the mating axis portions 520 has a cylindrical shape extending in an axis direction parallel to the width direction. The mating axis portions 520 are positioned at positions same as each other in a plane perpendicular to the width direction. The mating axis portions 520 correspond to the mating maintenance portions 540, respectively. Each of the mating axis portions 520 is positioned rearward of the corresponding mating maintenance portion 540 in a front-rear direction. Each of the mating axis portions 520 is positioned at a position same as a position of the corresponding mating maintenance portion 540 in the up-down direction. Each of the mating axis portions 520 is positioned at a position same as a position of the corresponding mating maintenance portion 540 in the width direction. In the present embodiment, the front-rear direction is an X-direction. Specifically, it is assumed that forward is a positive X-direction while rearward is a negative X-direction. Referring to FIGS. 3 and 7, each of the mating axis portions 520 is a rotation axis 520 with the axis direction.

As shown in FIG. 16, each of the mating maintenance portions 540 of the present embodiment is positioned in the receiving portion 514. The mating maintenance portions 540 are provided to correspond to the two side walls 512, respectively. Each of the mating maintenance portions 540 extend inward in the width direction from the corresponding side wall 512. Each of the mating maintenance portions 540 has a cylindrical shape extending in the width direction. The mating maintenance portions 540 are positioned at positions same as each other in the plane perpendicular to the width direction. Each of the mating maintenance portions 540 is positioned forward of the corresponding mating axis portion 520 in the front-rear direction. Each of the mating maintenance portions 540 is positioned at the position same as the position of the corresponding mating axis portion 520 in the up-down direction. Each of the mating maintenance portions 540 is positioned at the position same as the position of the corresponding mating axis portion 520 in the width direction.

As shown in FIG. 16, each of the mating maintenance portion 540 is a guide protrusion 570. In other words, the guide protrusion 570 functions as the mating maintenance portion 540. Each of the guide protrusions 570 has a cylindrical shape extending in the width direction.

As shown in FIG. 16, the mating housing 500 is further provided with mating guide portions 560.

As shown in FIG. 16, each of the mating guide portions 560 of the present embodiment is positioned in the receiving portion 514. The mating guide portions 560 are provided to correspond to the two side walls 512, respectively. Each of the mating guide portions 560 extends inward in the width direction from the correspond side wall 512. Each of the mating guide portions 560 has a cylindrical shape extending in the width direction. The mating guide portions 560 are positioned at positions same as each other in the plane perpendicular to the width direction. The mating guide portions 560 correspond to the mating axis portions 520, respectively. Each of the mating guide portions 560 is positioned forward of the corresponding mating axis portion 520 in the front-rear direction. Each of the mating guide portions 560 is positioned at a position same as the position of the corresponding mating axis portion 520 in the up-down direction. Each of the mating guide portions 560 is positioned at a position same as the position of the corresponding mating axis portion 520 in the width direction.

As shown in FIG. 16, each of the mating guide portions 560 is the guide protrusion 570. In other words, the guide protrusion 570 also functions as the mating guide portion 560.

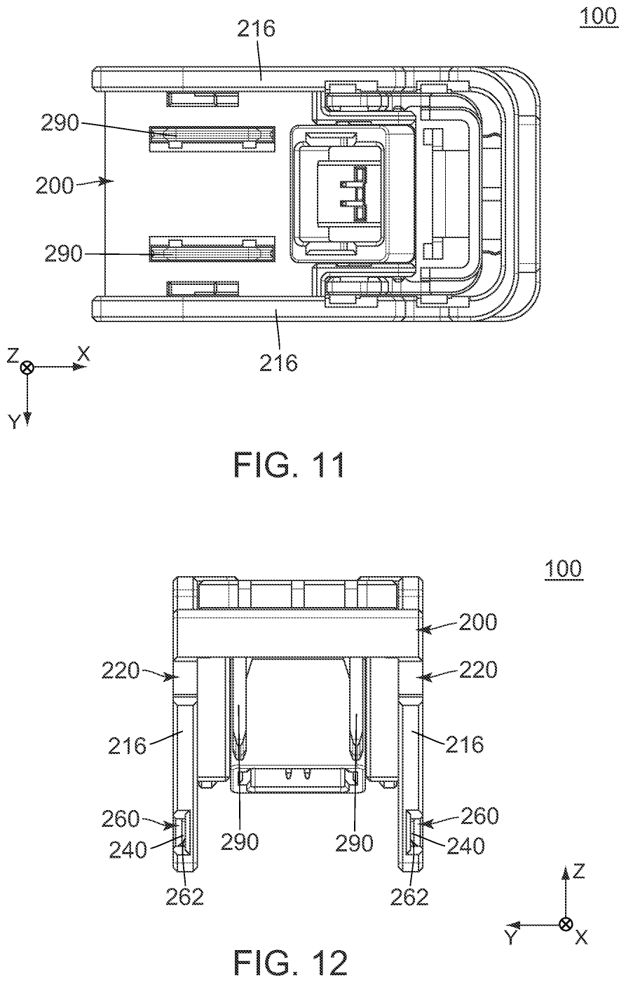

As shown in FIG. 11, the connector 100 of the present embodiment comprises a housing 200 and a terminal 290. Referring to FIG. 10, the connector 100 has no lever which is individually rotatable relative to the housing 200. Accordingly, the connector 100 of the present embodiment has a reduced number of components as compared to a connector with a lever which is individually rotatable relative to its housing.

As shown in FIG. 12, the housing 200 of the present embodiment holds the terminal 290. As shown in FIGS. 10 and 12, the housing 200 has an operation portion 210 and two side portions 216.

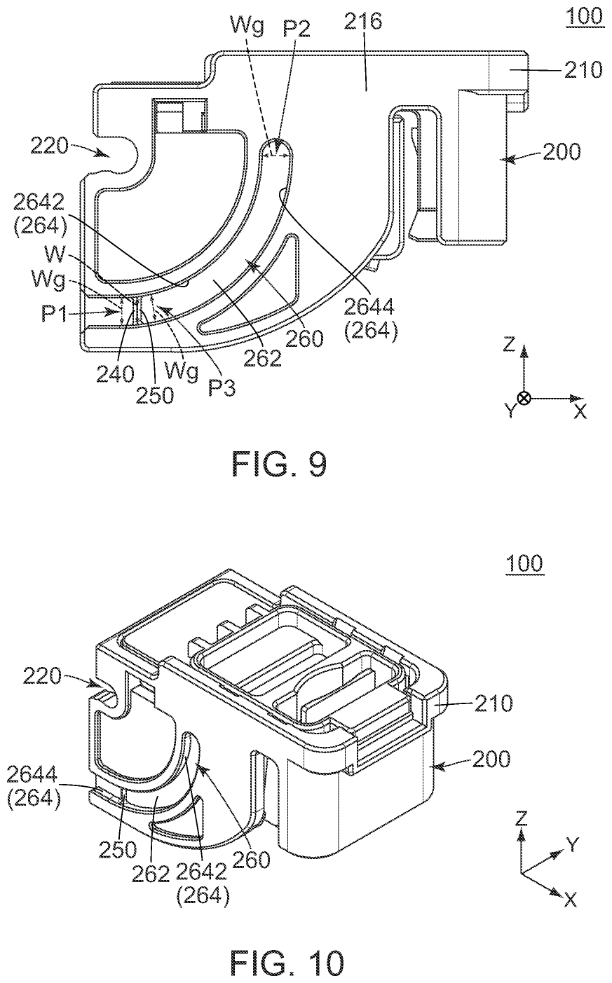

As shown in FIG. 9, the operation portion 210 of the present embodiment is positioned at a front end of the housing 200 in the front-rear direction.

As shown in FIG. 12, the side portions 216 of the present embodiment define opposite ends, respectively, of the housing 200 in the width direction. Each of the side portions 216 has a plate-like shape perpendicular to the width direction. Each of the side portions 216 is elastically deformable to some extent.

As shown in FIG. 12, the housing 200 is provided with two axis portions 220 and two maintenance portions 240.

As shown in FIG. 9, each of the axis portions 220 of the present embodiment is a bearing 220. As shown in FIG. 12, the axis portions 220 are provided to correspond to the two side portions 216, respectively. Each of the axis portions 220 is a hole piercing the corresponding side portion 216 in the width direction. The two axis portions 220 are positioned at positions same as each other in the plane perpendicular to the width direction. As shown in FIG. 3, the mating axis portions 520 are lightly press-fit into the bearings 220, respectively.

Although the connector device 10 of the present embodiment is configured so that the axis portion 220 is the bearing 220 while the mating axis portion 520 is the rotation axis 520 with the axis direction, the present invention is not limited thereto. Specifically, the connector device 10 may be configured so that the axis portion 220 is a rotation axis 520 with an axis direction while the mating axis portion 520 is a bearing 220. In other words, the connector device 10 should be configured so that one of the axis portion 220 and the mating axis portion 520 is the rotation axis 520 with the axis direction while a remaining one of the axis portion 220 and the mating axis portion 520 is the bearing 220.

Referring to FIGS. 3 and 7, when the axis portion 220 and the mating axis portion 520 are combined with each other, the connector 100 is rotatable around the rotation axis 520 between an open position OP and a close position CP.

As shown in FIG. 3, when the connector 100 is positioned at the open position OP, the connector 100 is positioned above the mating connector 400 in the up-down direction perpendicular to the axis direction of the rotation axis 520. When the connector 100 is positioned at the open position OP, each of the axis portions 220 is opened downward in the up-down direction perpendicular to the axis direction of the rotation axis 520. When the connector 100 is positioned at the open position OP, the connector 100 is separable from the mating connector 400 by the connector 100 being moved upward in the up-down direction.

As shown in FIG. 7, when the connector 100 is positioned at the close position CP, the connector 100 is in the mated state where the connector 100 is completely mated with the mating connector 400. When the connector 100 is positioned at the close position CP, a part of the housing 200 is received in the receiving portion 514 of the mating housing 500. When the connector 100 is positioned at the close position CP, each of the axis portions 220 is opened rearward in the front-rear direction perpendicular to the axis direction of the rotation axis 520.

As shown in FIG. 12, the maintenance portions 240 of the present embodiment are provided to correspond to the two side portions 216, respectively. Each of the maintenance portions 240 is bulged outward in the width direction. The two maintenance portions 240 are positioned at positions same as each other in the plane perpendicular to the width direction. As shown in FIG. 7, the maintenance portion 240 has a width W which is equal to or greater than a diameter R of the guide protrusion 570. In other words, the width W and the diameter R satisfy R≤W.

As shown in FIG. 3, when the connector 100 is positioned at the open position OP, the maintenance portion 240 is positioned forward of the axis portion 220 in the front-rear direction. When the connector 100 is positioned at the open position OP, the maintenance portion 240 is oblique to both the up-down direction and the width direction. When the connector 100 is positioned at the open position OP, the maintenance portion 240 extends upward in the up-down direction and outward in the width direction.

As shown in FIG. 7, when the connector 100 is positioned at the close position CP, the maintenance portion 240 is positioned rearward of a front end of the axis portion 220 in the front-rear direction. When the connector 100 is positioned at the close position CP, the maintenance portion 240 is positioned forward of a rear end of the housing 200 in the front-rear direction. When the connector 100 is positioned at the close position CP, the maintenance portion 240 is oblique to both the front-rear direction and the width direction.

Referring to FIG. 3, the maintenance portions 240 correspond to the mating maintenance portions 540, respectively. The maintenance portion 240 and the mating maintenance portion 540 temporarily maintain a position of the connector 100 at the open position OP. Specifically, the maintenance portion 240 and the corresponding mating maintenance portion 540 temporarily maintain the position of the connector 100 at the open position OP when the connector 100 is positioned at the open position OP. More specifically, when the connector 100 is positioned at the open position OP, the maintenance portion 240 is positioned above the corresponding mating maintenance portion 540 in the up-down direction and is brought into contact with the corresponding mating maintenance portion 540, and thereby the position of the connector 100 is temporarily maintained at the open position OP. Accordingly, in the connector device 10 of the present embodiment, the connector 100 can temporarily stand at the open position OP even when the connector 100 is not held by an operator.

As described above, the connector device 10 of the present embodiment is configured as follows: the connector 100 at the open position OP is separable from the mating connector 400; and the connector 100 can temporarily stand at the open position OP even when the connector 100 is not held by the operator. Accordingly, the connector 100 at the open position OP is prevented from being unintentionally rotated by its own weight from the open position OP toward the close position CP even if the operator changes a manner, in which the operator holds the connector 100, during the interval prior to an operation of separating the connector 100 from the mating connector 400 after the connector 100 is rotated from the close position CP to the open position OP. Thus, in the connector device 10 of the present embodiment, the connector 100 is prevented from abutting against the mating connector 400 by the connector 100 at the open position OP being unintentionally rotated to the close position CP, and the operation of separating the connector 100 from the mating connector 400 is facilitated.

In particular, the connector device 10 of the present embodiment is configured so that the mating axis portions 520 are lightly press-fit into the bearings 220, respectively, as described above. Accordingly, the operator must apply a slight force to the connector 100 when the connector 100 at the open position OP is separated from the mating connector 400. This requires the operator to change the manner, in which the operator holds the connector 100, during the interval prior to the operation of separating the connector 100 from the mating connector 400 after the connector 100 is rotated from the close position CP to the open position OP. On the other hand, the connector device 10 of the present embodiment is configured so that the connector 100 can temporarily stand at the open position OP even when the connector 100 is not held by the operator, as described above. This prevents the connector 100 at the open position OP from being unintentionally rotated from the open position OP to the close position CP by its own weight upon the changing of the manner. Thus, also in the connector device 10 of the present embodiment which is configured so that the mating axis portions 520 are lightly press-fit into the bearings 220, respectively, the connector 100 is prevented from abutting against the mating connector 400 by the connector 100 at the open position OP being unintentionally rotated to the close position CP, and the operation of separating the connector 100 from the mating connector 400 is facilitated.

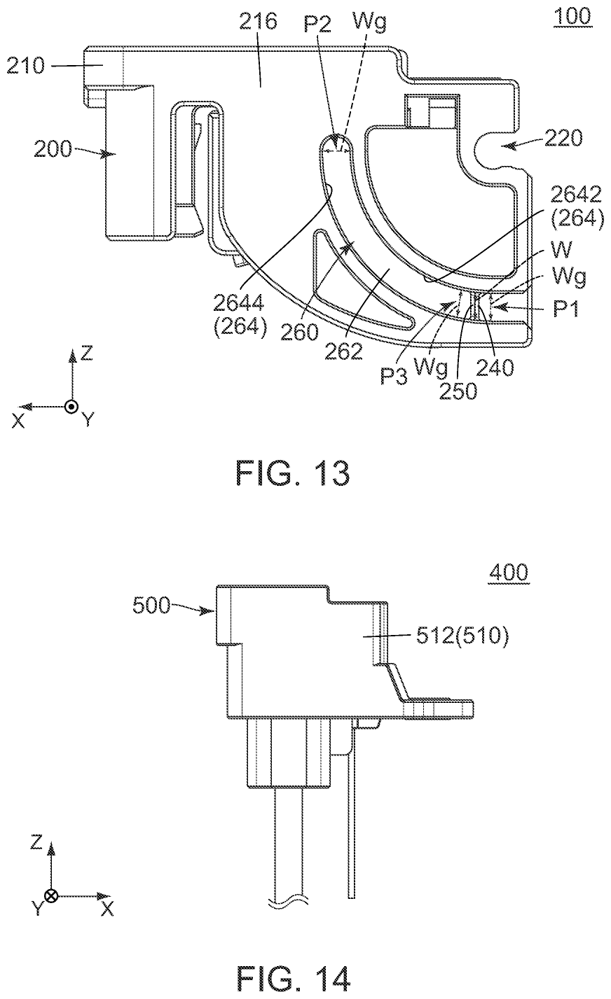

As shown in FIGS. 9 and 13, the housing 200 is further provided with two facing portions 250.

As shown in FIGS. 9 and 13, the facing portions 250 of the present embodiment are provided to correspond to the two side portions 216, respectively. Each of the facing portions 250 is bulged outward in the width direction. The two facing portion 250 are positioned at positions same as each other in the plane perpendicular to the width direction. Referring to FIG. 3, the facing portions 250 correspond to the maintenance portions 240 and the mating maintenance portions 540, respectively.

As shown in FIG. 3, when the connector 100 is positioned at the open position OP, each of the facing portions 250 is positioned above the corresponding maintenance portion 240 in the up-down direction. When the connector 100 is positioned at the open position OP, the facing portion 250 is positioned forward of the axis portion 220 in the front-rear direction. When the connector 100 is positioned at the open position OP, the facing portion 250 is oblique to both the up-down direction and the width direction. When the connector 100 is positioned at the open position OP, the facing portion 250 extends downward in the up-down direction and outward in the width direction.

As shown in FIG. 7, when the connector 100 is positioned at the close position CP, each of the facing portions 250 is positioned forward of the corresponding maintenance portion 240 in the front-rear direction. When the connector 100 is positioned at the close position CP, the facing portion 250 is positioned forward of the front end of the axis portion 220 in the front-rear direction. When the connector 100 is positioned at the close position CP, the facing portion 250 is positioned forward of the rear end of the housing 200 in the front-rear direction. When the connector 100 is positioned at the close position CP, the facing portion 250 is oblique to both the front-rear direction and the width direction.

As shown in FIGS. 9 and 13, the housing 200 is further provided with two guide portions 260.

As shown in FIG. 12, the guide portions 260 of the present embodiment are provided to correspond to the two side portions 216, respectively. Each of the guide portions 260 is a ditch which is formed on an outer surface of the corresponding side portion 216 in the width direction. Each of the guide portions 260 is recessed inward in the width direction. Referring to FIGS. 7 and 9, when the connector 100 is positioned at the close position CP, each of the guide portions 260 is opened at a rear end of the corresponding side portion 216 in the front-rear direction. Referring to FIGS. 9 and 13, the two guide portions 260 are positioned at positions same as each other in the plane perpendicular to the width direction. As shown in FIG. 9, each of the guide portions 260 extends from a first position P1 through a third position P3 to reach a second position P2. Each of the guide portions 260 has a constant width Wg from the first position P1 to the second position P2. The width Wg of the guide portion 260 is equal to the width W of the maintenance portion 240. In other words, the widths Wg and W satisfy Wg=W.

As shown in FIG. 3, when the connector 100 is positioned at the open position OP, the first position P1 is positioned forward of the second position P2 in the front-rear direction. When the connector 100 is positioned at the open position OP, the first position P1 is positioned below the second position P2 in the up-down direction. When the connector 100 is positioned at the open position OP, the first position P1 is positioned below the third position P3 in the up-down direction. When the connector 100 is positioned at the open position OP, the first position P1 is positioned forward of the axis portion 220 in the front-rear direction. When the connector 100 is positioned at the open position OP, the first position P1 is positioned at a position same as a position of the axis portion 220 in the up-down direction. When the connector 100 is positioned at the open position OP, the second position P2 is positioned at a position same as a position of the axis portion 220 in the front-rear direction. When the connector 100 is positioned at the open position OP, the second position P2 is positioned just above the axis portion 220 in the up-down direction. When the connector 100 is positioned at the open position OP, the third position P3 is positioned forward of the axis portion 220 in the front-rear direction. When the connector 100 is positioned at the open position OP, the third position P3 is positioned above the axis portion 220 in the up-down direction.

As shown in FIG. 7, when the connector 100 is positioned at the close position CP, the first position P1 is positioned rearward of the second position P2 in the front-rear direction. When the connector 100 is positioned at the close position CP, the first position P1 is positioned below the second position P2 in the up-down direction. When the connector 100 is positioned at the close position CP, the first position P1 is positioned at a position same as the position of the axis portion 220 in the front-rear direction. When the connector 100 is positioned at the close position CP, the first position P1 is positioned just below the axis portion 220 in the up-down direction. When the connector 100 is positioned at the close position CP, the second position P2 is positioned forward of the axis portion 220 in the front-rear direction. When the connector 100 is positioned at the close position CP, the second position P2 is positioned at a position same as the position of the axis portion 220 in the up-down direction. When the connector 100 is positioned at the close position CP, the third position P3 is positioned forward of the axis portion 220 in the front-rear direction. When the connector 100 is positioned at the close position CP, the third position P3 is positioned below the axis portion 220 in the up-down direction.

Referring to FIG. 3, the mating guide portions 560 are received in the guide portions 260, respectively, when the mating axis portions 520 are combined with the axis portions 220, respectively. Referring to FIGS. 3 and 7, the guide portion 260 and the mating guide portion 560 guide a rotational movement of the connector 100 between the open position OP and the close position CP. More specifically, when the connector 100 is rotated between the open position OP and the close position CP, each of the mating guide portions 560 continues to be received in the corresponding guide portion 260 and is moved along the corresponding guide portion 260. This configuration prevents the mating axis portion 520 from coming off the corresponding axis portion 220 upon the rotational movement of the connector 100. In other words, the guide portions 260 and the mating guide portions 560 of the present embodiment facilitate an operation of the connector 100 upon the rotational movement of the connector 100.

As shown in FIG. 9, each of the guide portions 260 is a guide ditch 260. The maintenance portions 240 are provided in the guide ditches 260, respectively. In other words, each of the maintenance portions 240 is a part of the corresponding guide ditch 260. As shown in FIG. 3, when the connector 100 is positioned at the open position OP, each of the guide protrusions 570 is positioned at the first position P1 in the corresponding guide ditch 260. As shown in FIG. 7, when the connector 100 is positioned at the close position CP, the guide protrusion 570 is positioned at the second position P2 in the corresponding guide ditch 260.

As shown in FIG. 9, each of the guide ditches 260 has a bottom surface 262 and two wall portions 264.

As shown in FIG. 12, the bottom surface 262 of the present embodiment defines an inner end of the guide portion 260 in the width direction. The bottom surface 262 is a plane perpendicular to the width direction. The bottom surface 262 faces outward in the width direction. As shown in FIG. 9, each of the maintenance portions 240 is provided in the corresponding guide ditch 260 at a location which is positioned beyond the first position P1 in an orientation from the first position P1 toward the second position P2. Each of the maintenance portions 240 is provided in the corresponding guide ditch 260 between the first position P1 and the third position P3. The facing portions 250 are provided in the guide ditches 260, respectively, at a location which is positioned beyond the first position P1 in the orientation from the first position P1 toward the second position P2. Each of the facing portions 250 is provided in the corresponding guide ditch 260 between the first position P1 and the third position P3. As shown in FIG. 12, each of the maintenance portions 240 is bulged from the bottom surface 262 in the corresponding guide ditch 260. Each of the maintenance portions 240 is bulged outward in the width direction from the bottom surface 262. Referring to FIGS. 9 and 12, each of the facing portions 250 is bulged from the bottom surface 262 in the corresponding guide ditch 260. Each of the facing portions 250 is bulged outward in the width direction from the bottom surface 262.

As shown in FIG. 9, each of the wall portions 264 of the present embodiment has an arc shape around the axis portion 220 in the plane perpendicular to the width direction. The maintenance portion 240 is positioned between the two wall portions 264. The facing portion 250 is positioned between the two wall portions 264. As shown in FIG. 12, in the width direction, an outer end of the maintenance portion 240 is positioned inward of an outer end of any of the wall portions 264. As shown in FIG. 10, in the width direction, an outer end of the facing portion 250 is positioned inward of the outer end of any of the wall portions 264.

As shown in FIG. 9, the wall portions 264 include an inner wall portion 2642 and an outer wall portion 2644.

As shown in FIG. 9, the inner wall portion 2642 of the present embodiment has an arc shape extending along an imaginary circle around the axis portion 220 in the plane perpendicular to the width direction. The inner wall portion 2642 is positioned inward of the outer wall portion 2644 in a radial direction of the imaginary circle. As shown in FIG. 12, in the width direction, the outer end of the maintenance portion 240 is positioned inward of an outer end of the inner wall portion 2642. As shown in FIG. 10, in the width direction, the outer end of the facing portion 250 is positioned inward of the outer end of the inner wall portion 2642.

As shown in FIG. 9, the outer wall portion 2644 of the present embodiment has an arc shape extending along an imaginary circle around the axis portion 220 in the plane perpendicular to the width direction. The outer wall portion 2644 is positioned outward of the inner wall portion 2642 in the radial direction. The maintenance portion 240 is positioned between the inner wall portion 2642 and the outer wall portion 2644. The facing portion 250 is positioned between the inner wall portion 2642 and the outer wall portion 2644. As shown in FIG. 12, in the width direction, the outer end of the maintenance portion 240 is positioned inward of an outer end of the outer wall portion 2644. As shown in FIG. 10, in the width direction, the outer end of the facing portion 250 is positioned inward of the outer end of the outer wall portion 2644.

Referring to FIG. 8, the terminal 290 of the present embodiment is made of metal. The terminal 290 has an angular C-shaped cross-section in a plane perpendicular to the front-rear direction. When the connector 100 is positioned at the close position CP, the terminal 290 is connected with both the mating terminals 590. As shown in FIG. 4, when the connector 100 is positioned at the open position OP, the terminal 290 is not connected with any of the mating terminals 590.

Hereinafter, an explanation will be made about states of portions of the connector device 10 upon the rotational movement of the connector 100 between the open position OP and the close position CP. In the following explanation, each of “clockwise rotation” and “counterclockwise rotation” specifies a rotational direction of the connector 100 of the connector device 10 that is seen along the positive Y-direction.

In the connector device 10 under a state shown in FIG. 3, the operator applies an external force to the operation portion 210 so that the connector 100 is rotated clockwise from the open position OP. Then, each of the guide protrusions 570 is pressed against the corresponding maintenance portion 240 from below. At this time, the maintenance portion 240 extends upward in the up-down direction and outward in the width direction. Accordingly, the maintenance portion 240 receives an inward force in the width direction from the corresponding guide protrusion 570 by the pressing. Thus, the side portion 216 is elastically deformed so that the maintenance portion 240 is moved inward in the width direction, and the guide protrusion 570 is moved from the first position P1 so that the maintenance portion 240 rides on the corresponding guide protrusion 570.

In this state where the maintenance portion 240 rides on the corresponding guide protrusion 570, the guide protrusion 570 is positioned between the two wall portions 264 while, in the width direction, an inner end of the guide protrusion 570 is positioned inward of the outer end of any of the two wall portions 264. This enables the mating guide portion 560 to continue to be received in the corresponding guide portion 260 also under the state where the maintenance portion 240 rides on the corresponding guide protrusion 570.

The operator continues to apply an external force to the operation portion 210 so that the connector 100 is further rotated clockwise under the state where the maintenance portion 240 rides on the corresponding guide protrusion 570. Then, the maintenance portion 240 rides over the corresponding guide protrusion 570, and the guide protrusion 570 reaches the third position P3 which is positioned above the corresponding facing portion 250, and the side portion 216 is restored to its original shape. After that, the operator continues to move the operation portion 210 so that the connector 100 is further rotated clockwise. Then, the guide protrusion 570 is moved along the corresponding guide ditch 260 to reach the second position P2. Thus, the connector device 10 changes its state into a state shown in FIG. 7 where the connector 100 is positioned at the close position CP.

In the connector device 10 under the state shown in FIG. 7, the operator applies an external force to the operation portion 210 so that the connector 100 is rotated counterclockwise from the close position CP. Then, the guide protrusion 570 is moved along the corresponding guide ditch 260 from the second position P2 to reach the third position P3, and the guide protrusion 570 abuts against the corresponding facing portion 250. In this state, the operator continues to apply an external force to the operation portion 210 so that the connector 100 is further rotated counterclockwise. Then, the guide protrusion 570 is pressed against the corresponding facing portion 250 from above. At this time, the facing portion 250 extends downward in the up-down direction and outward in the width direction. Accordingly, the facing portion 250 receives an inward force in the width direction from the corresponding guide protrusion 570 by the pressing. Thus, the side portion 216 is elastically deformed so that the facing portion 250 is moved inward in the width direction, and the facing portion 250 rides on the corresponding guide protrusion 570.

In this state where the facing portion 250 rides on the corresponding guide protrusion 570, the guide protrusion 570 is positioned between the two wall portions 264 while, in the width direction, the inner end of the guide protrusion 570 is positioned inward of the outer end of any of the two wall portions 264. This enables the mating guide portion 560 to continue to be received in the corresponding guide portion 260 also under the state where the facing portion 250 rides on the corresponding guide protrusion 570.

The operator continues to apply an external force to the operation portion 210 so that the connector 100 is further rotated counterclockwise under the state where the facing portion 250 rides on the corresponding guide protrusion 570. Then, the facing portion 250 rides over the corresponding guide protrusion 570, and the guide protrusion 570 reaches the first position P1 which is positioned below the maintenance portion 240, and the side portion 216 is restored to its original shape. Thus, the connector device 10 changes its state into the state shown in FIG. 3 where the connector 100 is positioned at the open position OP. In the state shown in FIG. 3, the maintenance portion 240 is positioned above the corresponding mating maintenance portion 540 in the up-down direction and is brought into contact with the corresponding mating maintenance portion 540, and thereby the position of the connector 100 is temporarily maintained at the open position OP. Thus, in the state shown in FIG. 3, the connector 100 can temporarily stand at the open position OP even when the connector 100 is not held by the operator.

Where the present embodiment of the present invention is described above, the present embodiment may be modified as follows.

(First modification)

As shown in FIG. 18, a connector device 10A according to a first modification comprises a connector 100A and a mating connector 400. The mating connector 400 of the present modification has a structure same as that of the mating connector 400 of the aforementioned embodiment. Accordingly, a detailed explanation thereabout is omitted.

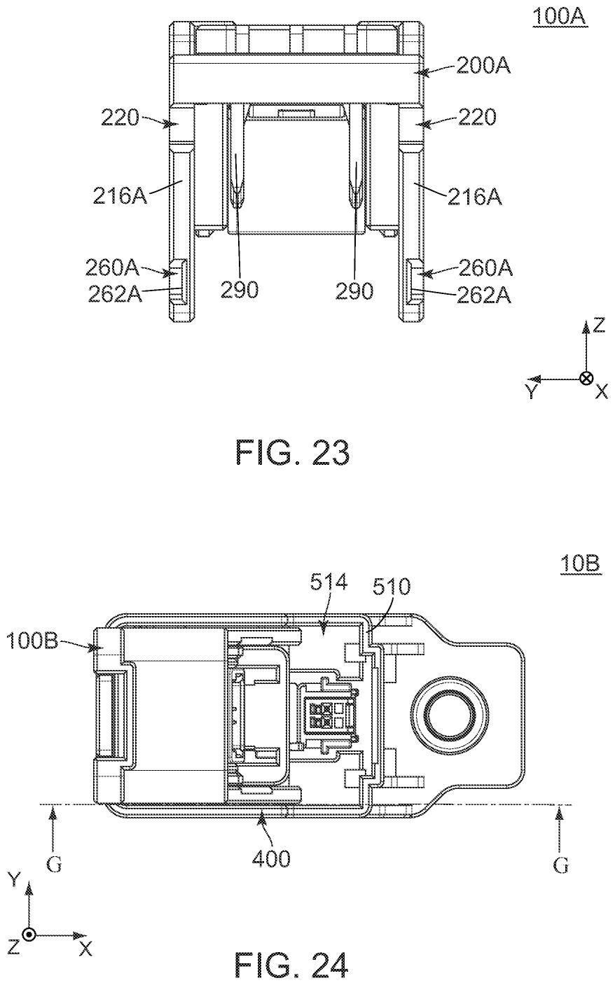

As shown in FIG. 23, the connector 100A of the present modification comprises a housing 200A and a terminal 290. The terminal 290 of the present modification has a structure same as that of the terminal 290 of the aforementioned embodiment. Accordingly, a detailed explanation thereabout is omitted.

As shown in FIG. 23, the housing 200A of the present modification holds the terminal 290. The housing 200A has two side portions 216A. The side portion 216A of the present modification has a structures similar to that of the side portion 216 of the aforementioned embodiment. Accordingly, a detailed explanation thereabout is omitted.

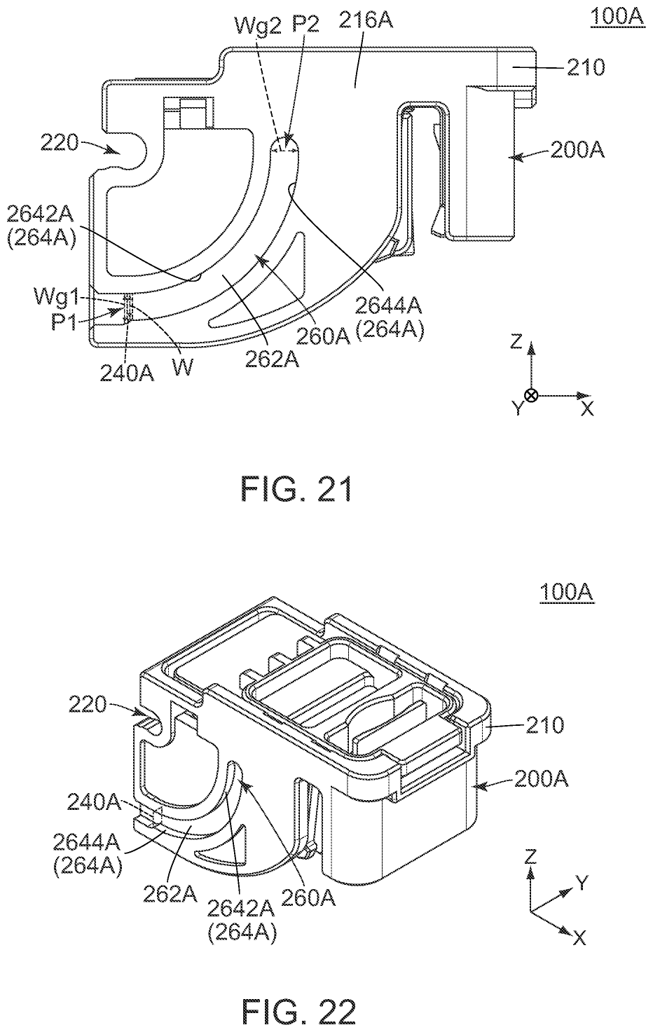

Referring to FIG. 21, the housing 200A is provided with two axis portions 220 and two maintenance portions 240A. The axis portion 220 of the present modification has a structure same as that of the axis portion 220 of the aforementioned embodiment. Accordingly, a detailed explanation thereabout is omitted.

Referring to FIGS. 18 and 20, when the axis portion 220 and a mating axis portion 520 are combined with each other, the connector 100A is rotatable around a rotation axis 520 between an open position OP and a close position CP.

As shown in FIG. 18, when the connector 100A is positioned at the open position OP, the connector 100A is positioned above the mating connector 400 in the up-down direction perpendicular to an axis direction of the rotation axis 520. When the connector 100A is positioned at the open position OP, each of the axis portions 220 is opened downward in the up-down direction perpendicular to the axis direction of the rotation axis 520. When the connector 100A is positioned at the open position OP, the connector 100A is separable from the mating connector 400 by the connector 100A being moved upward in the up-down direction.

As shown in FIG. 21, the maintenance portions 240A of the present modification are provided to correspond to the two side portions 216A, respectively. The two maintenance portions 240A are positioned at positions same as each other in a plane perpendicular to the width direction. As shown in FIG. 20, the maintenance portion 240A has a width W which is smaller than a diameter R of a guide protrusion 570. In other words, the width W and the diameter R satisfy W<R.

As shown in FIG. 18, when the connector 100A is positioned at the open position OP, the maintenance portion 240A is positioned forward of the axis portion 220 in the front-rear direction. As shown in FIG. 20, when the connector 100A is positioned at the close position CP, the maintenance portion 240A is positioned rearward of a front end of the axis portion 220 in the front-rear direction. When the connector 100A is positioned at the close position CP, the maintenance portion 240A is positioned forward of a rear end of the housing 200A in the front-rear direction.

Referring to FIG. 18, the maintenance portions 240A correspond to mating maintenance portions 540, respectively. The maintenance portion 240A and the mating maintenance portion 540 temporarily maintain a position of the connector 100A at the open position OP. Specifically, the maintenance portion 240A and the corresponding mating maintenance portion 540 temporarily maintain the position of the connector 100A at the open position OP when the connector 100A is positioned at the open position OP. More specifically, when the connector 100A is positioned at the open position OP, the maintenance portion 240A sandwiches the guide protrusion 570, which functions as the corresponding mating maintenance portion 540, in the front-rear direction, and thereby the position of the connector 100A is temporarily maintained at the open position OP. Accordingly, the connector device 10A of the present modification is configured so that the connector 100A can temporarily stand at the open position OP even when the connector 100A is not held by an operator.

Similar to the connector device 10 of the aforementioned embodiment, the connector device 10A of the present modification is also configured as follows: the connector 100A at the open position OP is separable from the mating connector 400; and the connector 100A can temporarily stand at the open position OP even when the connector 100A is not held by the operator. Accordingly, the connector 100A at the open position OP is prevented from being unintentionally rotated by its own weight from the open position OP toward the close position CP even if the operator changes a manner, in which the operator holds the connector 100A, during an interval prior to an operation of separating the connector 100A from the mating connector 400 after the connector 100A is rotated from the close position CP to the open position OP. Thus, in the connector device 10A of the present modification, the connector 100A is prevented from abutting against the mating connector 400 by the connector 100A at the open position OP being unintentionally rotated to the close position CP, and the operation of separating the connector 100A from the mating connector 400 is facilitated.

Referring to FIG. 21, the housing 200A is further provided with two guide portions 260A.

As shown in FIG. 23, the guide portions 260A of the present modification are provided to correspond to the two side portions 216A, respectively. Each of the guide portions 260A is a ditch which is formed on an outer surface of the corresponding side portion 216A in the width direction. Each of the guide portions 260A is recessed inward in the width direction. Referring to FIGS. 21 and 22, when the connector 100A is positioned at the close position CP, each of the guide portions 260A is opened at a rear end of the corresponding side portion 216A in the front-rear direction. Referring to FIG. 21, the two guide portions 260A are positioned at positions same as each other in the plane perpendicular to the width direction. Each of the guide portions 260A extends from a first position P1 to a second position P2. As shown in FIG. 20, a width Wg1 of the guide portion 260A at the first position P1 is greater than the width W of the maintenance portion 240A. In other words, the widths Wg1 and W satisfy Wg1>W. The width Wg1 of the guide portion 260A at the first position P1 is greater than the diameter R of the guide protrusion 570. In other words, the width Wg1 and the diameter R satisfy Wg1>R. A width Wg2 of the guide portion 260A at the second position P2 is greater than the width W of the maintenance portion 240A. In other words, the widths Wg2 and W satisfy Wg2>W. The width Wg2 of the guide portion 260A at the second position P2 is greater than the diameter R of the guide protrusion 570. In other words, the width Wg2 and the diameter R satisfy Wg2>R.

As shown in FIG. 18, when the connector 100A is positioned at the open position OP, the first position P1 is positioned forward of the second position P2 in the front-rear direction. When the connector 100A is positioned at the open position OP, the first position P1 is positioned below the second position P2 in the up-down direction. When the connector 100A is positioned at the open position OP, the first position P1 is positioned below the maintenance portion 240A in the up-down direction. When the connector 100A is positioned at the open position OP, the first position P1 is positioned forward of the axis portion 220 in the front-rear direction. When the connector 100A is positioned at the open position OP, the first position P1 is positioned at a position same as a position of the axis portion 220 in the up-down direction. When the connector 100A is positioned at the open position OP, the second position P2 is positioned at a position same as a position of the axis portion 220 in the front-rear direction. When the connector 100A is positioned at the open position OP, the second position P2 is positioned just above the axis portion 220 in the up-down direction. When the connector 100A is positioned at the open position OP, the maintenance portion 240A is positioned forward of the axis portion 220 in the front-rear direction. When the connector 100A is positioned at the open position OP, the maintenance portion 240A is positioned at a position same as the position of the axis portion 220 in the up-down direction.

As shown in FIG. 20, when the connector 100A is positioned at the close position CP, the first position P1 is positioned rearward of the second position P2 in the front-rear direction. When the connector 100A is positioned at the close position CP, the first position P1 is positioned below the second position P2 in the up-down direction. When the connector 100A is positioned at the close position CP, the first position P1 is positioned at a position same as the position of the axis portion 220 in the front-rear direction. When the connector 100A is positioned at the close position CP, the first position P1 is positioned just below the axis portion 220 in the up-down direction. When the connector 100A is positioned at the close position CP, the second position P2 is positioned forward of the axis portion 220 in the front-rear direction. When the connector 100A is positioned at the close position CP, the second position P2 is positioned at a position same as the position of the axis portion 220 in the up-down direction. When the connector 100A is positioned at the close position CP, the maintenance portion 240A is positioned at a position same as the position of the axis portion 220 in the front-rear direction. When the connector 100A is positioned at the close position CP, the maintenance portion 240A is positioned just below the axis portion 220 in the up-down direction.

Referring to FIG. 18, mating guide portions 560 are received in the guide portions 260A, respectively, when the mating axis portions 520 are combined with the axis portions 220, respectively. Referring to FIGS. 18 and 20, the guide portion 260A and the mating guide portion 560 guide a rotational movement of the connector 100A between the open position OP and the close position CP. More specifically, when the connector 100A is rotated between the open position OP and the close position CP, each of the mating guide portions 560 continues to be received in the corresponding guide portion 260A and is moved along the corresponding guide portion 260A. This configuration prevents the mating axis portion 520 from coming off the corresponding axis portion 220 upon the rotational movement of the connector 100A. In other words, the guide portions 260A and the mating guide portions 560 of the present modification facilitate an operation of the connector 100A upon the rotational movement of the connector 100A.

As shown in FIG. 21, each of the guide portions 260A is a guide ditch 260A. The maintenance portions 240A are provided in the guide ditches 260A, respectively. In other words, each of the maintenance portions 240A is a part of the corresponding guide ditch 260A. As shown in FIG. 18, when the connector 100A is positioned at the open position OP, the guide protrusion 570 is positioned at the first position P1 in the guide ditch 260A. As shown in FIG. 20, when the connector 100A is positioned at the close position CP, the guide protrusion 570 is positioned at the second position P2 in the guide ditch 260A.

As shown in FIG. 21, each of the guide ditches 260A has a bottom surface 262A and two wall portions 264A.

As shown in FIG. 23, the bottom surface 262A of the present modification defines an inner end of the guide portion 260A in the width direction. The bottom surface 262A is a plane perpendicular to the width direction. The bottom surface 262A faces outward in the width direction. As shown in FIG. 21, each of the maintenance portions 240A is provided in the corresponding guide ditch 260A at a location which is positioned beyond the first position P1 in an orientation from the first position P1 toward the second position P2. It is noted that, dissimilar to the maintenance portion 240 of the aforementioned embodiment, the maintenance portion 240A of the present modification is not bulged from the bottom surface 262A in the guide ditch 260A.

As shown in FIG. 21, the wall portions 264A include an inner wall portion 2642A and an outer wall portion 2644A.

As shown in FIG. 21, the inner wall portion 2642A of the present modification has an arc shape extending along an imaginary circle around the axis portion 220 in the plane perpendicular to the width direction. The inner wall portion 2642A has a constant radius of curvature from the first position P1 to the second position P2. The inner wall portion 2642A is positioned inward of the outer wall portion 2644A in a radial direction of the imaginary circle.

As shown in FIG. 21, the outer wall portion 2644A of the present modification has a substantially arc shape substantially extending along an imaginary circle around the axis portion 220 in the plane perpendicular to the width direction. The outer wall portion 2644A has a decreasing radius of curvature from the second position P2 toward the maintenance portion 240A. The outer wall portion 2644A is positioned outward of the inner wall portion 2642A in the radial direction. The maintenance portion 240A is positioned between the inner wall portion 2642A and the outer wall portion 2644A.

Although the wall portions 264A of the present modification are configured so that the inner wall portion 2642A has the constant radius of curvature from the first position P1 to the second position P2 while the outer wall portion 2644A has the decreasing radius of curvature from the second position P2 toward the maintenance portion 240A, the present invention is not limited thereto. Specifically, the wall portions 264A may be configured so that the inner wall portion 2642A has an increasing radius of curvature from the second position P2 toward the maintenance portion 240A while the outer wall portion 2644A has a constant radius of curvature from the first position P1 to the second position P2.

Hereinafter, an explanation will be made about states of portions of the connector device 10A upon the rotational movement of the connector 100A between the open position OP and the close position CP. In the following explanation, each of “clockwise rotation” and “counterclockwise rotation” specifies a rotational direction of the connector 100A of the connector device 10A that is seen along the positive Y-direction.

In the connector device 10A under a state shown in FIG. 18, the operator applies an external force to an operation portion 210 so that the connector 100A is rotated clockwise from the open position OP. Then, the guide protrusion 570 is moved along the corresponding guide ditch 260A from the first position P1 to reach the second position P2 while the guide protrusion 570 breaks contact with the wall portions 264A. Thus, the connector device 10A changes its state into a state shown in FIG. 20 where the connector 100A is positioned at the close position CP.

In the connector device 10A under the state shown in FIG. 20, the operator applies an external force to the operation portion 210 so that the connector 100A is rotated counterclockwise from the close position CP. Then, the guide protrusion 570 is moved along the corresponding guide ditch 260A from the second position P2 and is sandwiched by the wall portions 264A.

In this state, the operator continues to apply an external force to the operation portion 210 so that the connector 100A is further rotated counterclockwise. Then, the guide protrusion 570 is moved along the corresponding guide ditch 260A while expanding a distance between the wall portions 264A in the width direction, and the guide protrusion 570 reaches the first position P1. Thus, the connector device 10A changes its state into the state shown in FIG. 18 where the connector 100A is positioned at the open position OP. In the state shown in FIG. 18, the maintenance portion 240A sandwiches the corresponding mating maintenance portion 540, and thereby the position of the connector 100A is temporarily maintained at the open position OP. Thus, in the state shown in FIG. 18, the connector 100A can temporarily stand at the open position OP even when the connector 100A is not held by the operator.

(Second Modification)

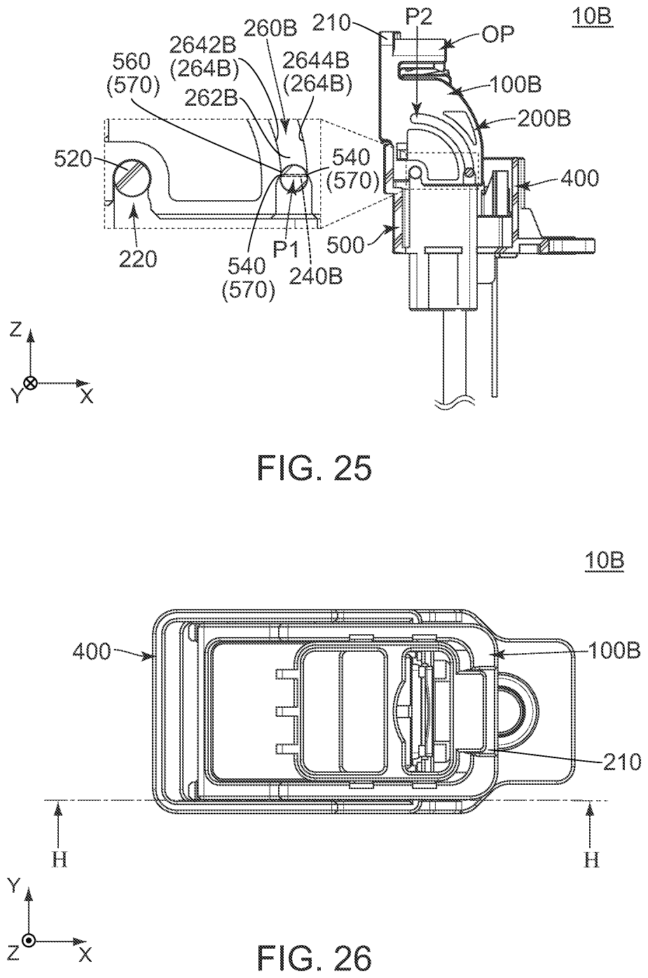

As shown in FIG. 25, a connector device 10B according to a second modification comprises a connector 100B and a mating connector 400. The mating connector 400 of the present modification has a structure same as that of the mating connector 400 of the aforementioned embodiment. Accordingly, a detailed explanation thereabout is omitted.

As shown in FIG. 30, the connector 100B of the present modification comprises a housing 200B and a terminal 290. The terminal 290 of the present modification has a structure same as that of the terminal 290 of the aforementioned embodiment. Accordingly, a detailed explanation thereabout is omitted.

As shown in FIG. 30, the housing 200B of the present modification holds the terminal 290. The housing 200B has two side portions 216B. The side portion 216B of the present modification has a structures similar to that of the side portion 216 of the aforementioned embodiment. Accordingly, a detailed explanation thereabout is omitted.

Referring to FIG. 28, the housing 200B is provided with two axis portions 220 and two maintenance portions 240B. The axis portion 220 of the present modification has a structure same as that of the axis portion 220 of the aforementioned embodiment. Accordingly, a detailed explanation thereabout is omitted.

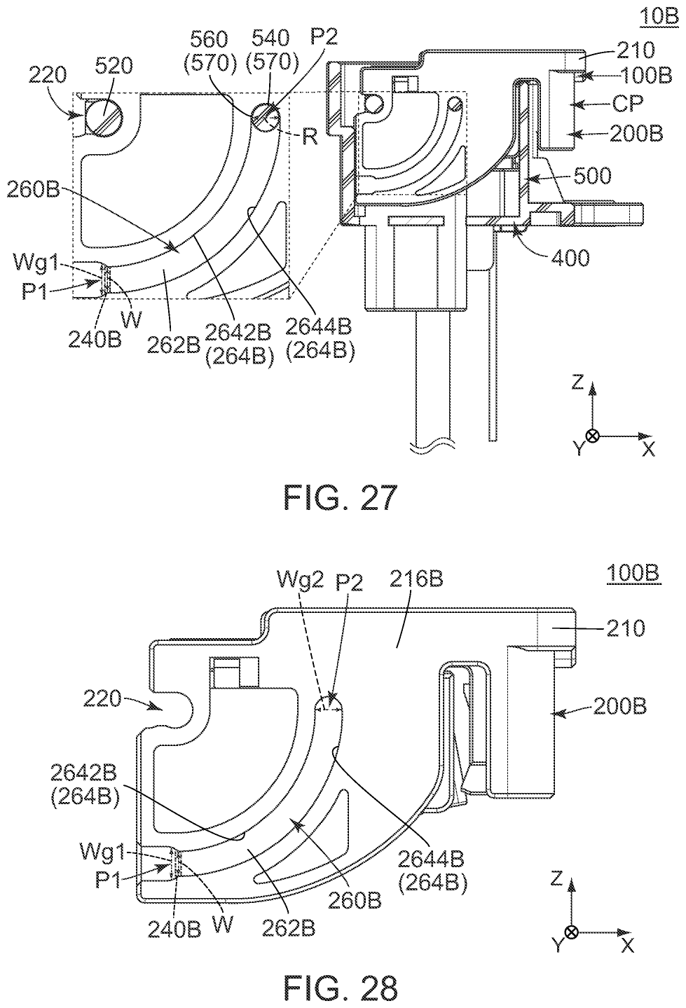

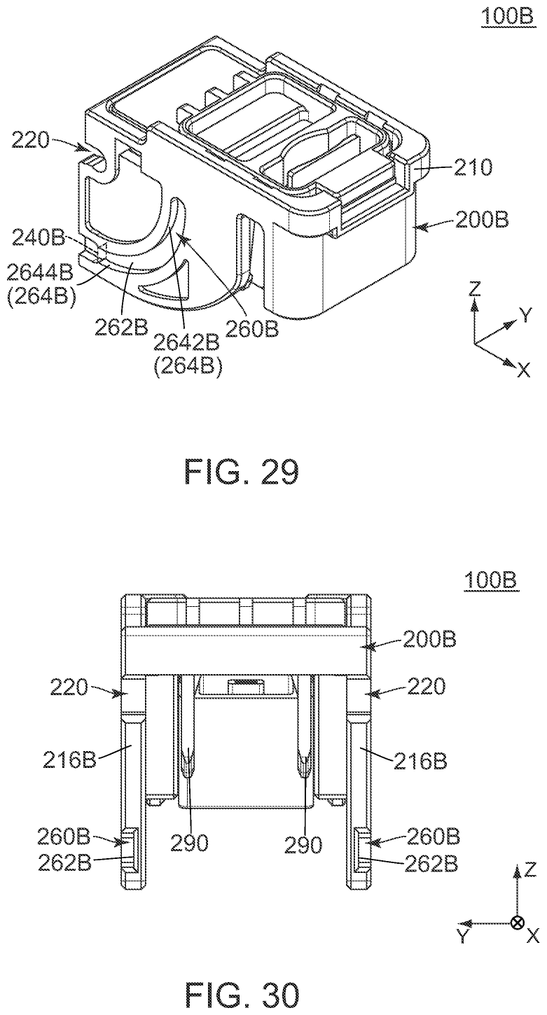

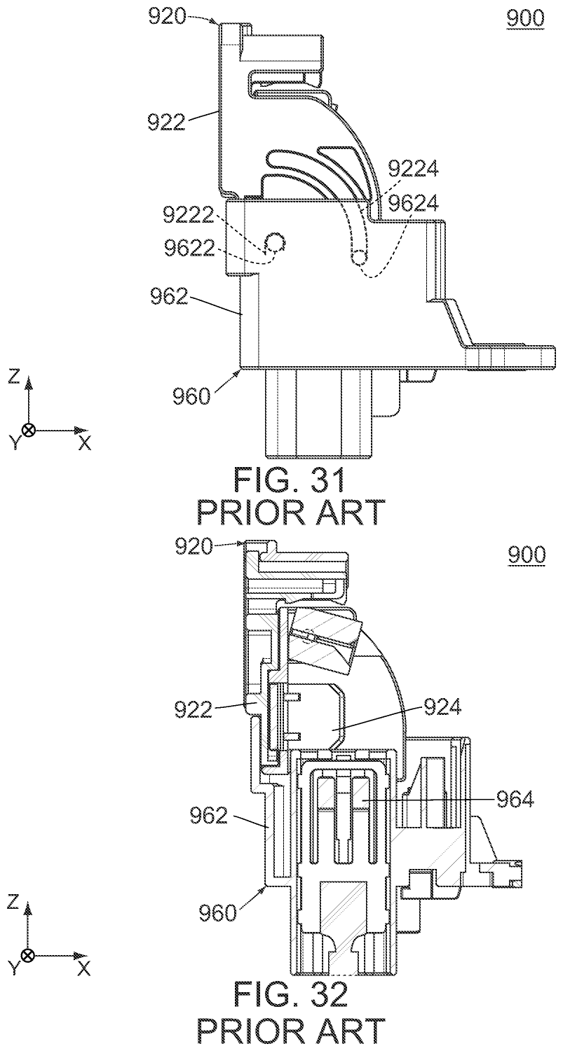

Referring to FIGS. 25 and 27, when the axis portion 220 and a mating axis portion 520 are combined with each other, the connector 1008 is rotatable around a rotation axis 520 between an open position OP and a close position CP.

As shown in FIG. 25, when the connector 1008 is positioned at the open position OP, the connector 1008 is positioned above the mating connector 400 in the up-down direction perpendicular to an axis direction of the rotation axis 520. When the connector 100B is positioned at the open position OP, each of the axis portions 220 is opened downward in the up-down direction perpendicular to the axis direction of the rotation axis 520. When the connector 1008 is positioned at the open position OP, the connector 1008 is separable from the mating connector 400 by the connector 100 being moved upward in the up-down direction.

Referring to FIG. 28, the maintenance portions 240B of the present modification are provided to correspond to the two side portions 2168, respectively. The two maintenance portions 240B are positioned at positions same as each other in a plane perpendicular to the width direction. As shown in FIG. 27, the maintenance portion 240B has a width W which is smaller than a diameter R of a guide protrusion 570. In other words, the width W and the diameter R satisfy W<R.

As shown in FIG. 25, when the connector 1008 is positioned at the open position OP, the maintenance portion 240B is positioned forward of the axis portion 220 in the front-rear direction. As shown in FIG. 27, when the connector 1008 is positioned at the close position CP, the maintenance portion 240B is positioned rearward of a front end of the axis portion 220 in the front-rear direction. When the connector 100B is positioned at the close position CP, the maintenance portion 240B is positioned forward of a rear end of the housing 200B in the front-rear direction.

Referring to FIG. 25, the maintenance portions 240B correspond to mating maintenance portions 540, respectively. The maintenance portion 240B and the mating maintenance portion 540 temporarily maintain a position of the connector 1008 at the open position OP. Specifically, the maintenance portion 240B and the corresponding mating maintenance portion 540 temporarily maintain the position of the connector 100B at the open position OP when the connector 100B is positioned at the open position OP. More specifically, when the connector 100B is positioned at the open position OP, the maintenance portion 240B sandwiches the guide protrusion 570, which functions as the corresponding mating maintenance portion 540, in the front-rear direction, and thereby the position of the connector 100B is temporarily maintained at the open position OP. Accordingly, the connector device 10B of the present modification is configured so that the connector 100B can temporarily stand at the open position OP even when the connector 100B is not held by an operator.

Similar to any of the connector devices 10, 10A of the aforementioned embodiment and the first modification, the connector device 10B of the present modification is also configured as follows: the connector 100B at the open position OP is separable from the mating connector 400; and the connector 100B can temporarily stand at the open position OP even when the connector 100B is not held by the operator. Accordingly, the connector 100B at the open position OP is prevented from being unintentionally rotated by its own weight from the open position OP toward the close position CP even if the operator changes a manner, in which the operator holds the connector 100B, during an interval prior to an operation of separating the connector 100B from the mating connector 400 after the connector 100B is rotated from the close position CP to the open position OP. Thus, in the connector device 10B of the present modification, the connector 100B is prevented from abutting against the mating connector 400 by the connector 100B at the open position OP being unintentionally rotated to the close position CP, and the operation of separating the connector 100B from the mating connector 400 is facilitated.

Referring to FIG. 28, the housing 200B is further provided with two guide portions 260B.

As shown in FIG. 28, the guide portions 260B of the present modification are provided to correspond to the two side portions 2168, respectively. Each of the guide portions 260B is a ditch which is formed on an outer surface of the corresponding side portion 2168 in the width direction. Each of the guide portions 260B is recessed inward in the width direction. Referring to FIGS. 27 and 28, when the connector 1008 is positioned at the close position CP, each of the guide portions 260B is opened at a rear end of the corresponding side portion 2168 in the front-rear direction. Referring to FIG. 28, the two guide portions 260B are positioned at positions same as each other in the plane perpendicular to the width direction. Each of the guide portions 260B extends from a first position P1 to a second position P2. As shown in FIG. 27, a width Wg1 of the guide portion 260B at the first position P1 is greater than the width W of the maintenance portion 240B. In other words, the widths Wg1 and W satisfy Wg1>W. The width Wg1 of the guide portion 260B at the first position P1 is greater than the diameter R of the guide protrusion 570. In other words, the width Wg1 and the diameter R satisfy Wg1>R. A width Wg2 of the guide portion 260B at the second position P2 is greater than the width W of the maintenance portion 240B. In other words, the widths Wg2 and W satisfy Wg2>W. The width Wg2 of the guide portion 260B at the second position P2 is greater than the diameter R of the guide protrusion 570. In other words, the width Wg2 and the diameter R satisfy Wg2>R.

As shown in FIG. 25, when the connector 1008 is positioned at the open position OP, the first position P1 is positioned forward of the second position P2 in the front-rear direction. When the connector 1008 is positioned at the open position OP, the first position P1 is positioned below the second position P2 in the up-down direction. When the connector 1008 is positioned at the open position OP, the first position P1 is positioned below the maintenance portion 240B in the up-down direction. When the connector 1008 is positioned at the open position OP, the first position P1 is positioned forward of the axis portion 220 in the front-rear direction. When the connector 1008 is positioned at the open position OP, the first position P1 is positioned at a position same as a position of the axis portion 220 in the up-down direction. When the connector 1008 is positioned at the open position OP, the second position P2 is positioned at a position same as a position of the axis portion 220 in the front-rear direction. When the connector 1008 is positioned at the open position OP, the second position P2 is positioned just above the axis portion 220 in the up-down direction. When the connector 1008 is positioned at the open position OP, the maintenance portion 240B is positioned forward of the axis portion 220 in the front-rear direction. When the connector 1008 is positioned at the open position OP, the maintenance portion 240B is positioned at a position same as the position of the axis portion 220 in the up-down direction.

As shown in FIG. 27, when the connector 1008 is positioned at the close position CP, the first position P1 is positioned rearward of the second position P2 in the front-rear direction. When the connector 1008 is positioned at the close position CP, the first position P1 is positioned below the second position P2 in the up-down direction. When the connector 1008 is positioned at the close position CP, the first position P1 is positioned at the position same as the position of the maintenance portion 240B in the up-down direction. When the connector 1008 is positioned at the close position CP, the first position P1 is positioned at a position same as the position of the axis portion 220 in the front-rear direction. When the connector 1008 is positioned at the close position CP, the first position P1 is positioned just below the axis portion 220 in the up-down direction. When the connector 1008 is positioned at the close position CP, the second position P2 is positioned forward of the axis portion 220 in the front-rear direction. When the connector 1008 is positioned at the close position CP, the second position P2 is positioned at a position same as the position of the axis portion 220 in the up-down direction. When the connector 100B is positioned at the close position CP, the maintenance portion 240B is positioned at a position same as the position of the axis portion 220 in the front-rear direction. When the connector 100B is positioned at the close position CP, the maintenance portion 240B is positioned just below the axis portion 220 in the up-down direction.

Referring to FIG. 25, mating guide portions 560 are received in the guide portions 260B, respectively, when the mating axis portions 520 are combined with the axis portions 220, respectively. Referring to FIGS. 25 and 27, the guide portion 260B and the mating guide portion 560 guide a rotational movement of the connector 1008 between the open position OP and the close position CP. More specifically, when the connector 100B is rotated between the open position OP and the close position CP, each of the mating guide portions 560 continues to be received in the corresponding guide portion 260B and is moved along the corresponding guide portion 260B. This configuration prevents the mating axis portion 520 from coming off the corresponding axis portion 220 upon the rotational movement of the connector 1008. In other words, the guide portions 260B and the mating guide portions 560 of the present modification facilitate an operation of the connector 1008 upon the rotational movement of the connector 1008.

As shown in FIG. 28, each of the guide portions 260B is a guide ditch 260B. The maintenance portions 240B are provided in the guide ditches 260B, respectively. In other words, each of the maintenance portions 240B is a part of the corresponding guide ditch 2608. As shown in FIG. 25, when the connector 1008 is positioned at the open position OP, the guide protrusion 570 is positioned at the first position P1 in the guide ditch 260B. As shown in FIG. 27, when the connector 1008 is positioned at close position CP, the guide protrusion 570 is positioned at the second position P2 in the guide ditch 2608.

As shown in FIG. 28, each of the guide ditches 260B has a bottom surface 262B and two wall portions 264B.

As shown in FIG. 30, the bottom surface 262B of the present modification defines an inner end of the guide portion 260B in the width direction. The bottom surface 262B is a plane perpendicular to the width direction. The bottom surface 262B faces outward in the width direction. As shown in FIG. 28, each of the maintenance portions 240B is provided in the corresponding guide ditch 260B at a location which is positioned beyond the first position P1 in an orientation from the first position P1 toward the second position P2. It is noted that, similar to the maintenance portion 240A of the aforementioned first modification, the maintenance portion 240B of the present modification is not bulged from the bottom surface 262B in the corresponding guide ditch 2608.

As shown in FIG. 28, each of the wall portions 264B has a substantially arc shape around the axis portion 220 in the plane perpendicular to the width direction. The maintenance portion 240B is positioned between the two wall portions 264B. The wall portions 264B include an inner wall portion 2642B and an outer wall portion 2644B.

As shown in FIG. 28, the inner wall portion 2642B of the present modification has a substantially arc shape substantially extending along an imaginary circle around the axis portion 220 in the plane perpendicular to the width direction. The inner wall portion 2642B has an increasing radius of curvature from the second position P2 toward the maintenance portion 240B. The inner wall portion 2642B is positioned inward of the outer wall portion 2644B in a radial direction of the imaginary circle.

As shown in FIG. 28, the outer wall portion 2644B of the present modification has a substantially arc shape substantially extending along an imaginary circle around the axis portion 220 in the plane perpendicular to the width direction. The outer wall portion 2644B has a decreasing radius of curvature from the second position P2 toward the maintenance portion 240B. The outer wall portion 2644B is positioned outward of the inner wall portion 2642B in the radial direction. The maintenance portion 240B is positioned between the inner wall portion 2642B and the outer wall portion 2644B.

States of portions of the connector device 10B upon the rotational movement of the connector 100B between the open position OP and the close position CP are similar to those of the aforementioned first modification. Accordingly, a detailed explanation thereabout is omitted.

Although the specific explanation about the present invention is made above referring to the embodiment and modifications, the present invention is not limited thereto and is susceptible to various modifications and alternative forms.

Although the connector devices 10, 10A, 10B of the present embodiment and modifications are configured so that the mating guide portion 560 is the guide protrusion 570 while the guide portion 260, 260A, 260B is the guide ditch 260, 260A, 260B which receives the guide protrusion 570 to guide the rotational movement of the connector 100, 100A, 100B, the present invention is not limited thereto. Specifically, the connector device 10, 10A, 10B may be configured so that the guide portion 260, 260A, 260B is the guide protrusion 570 while the mating guide portion 560 is the guide ditch 260, 260A, 260B which receives the guide protrusion 570 to guide the rotational movement of the connector 100, 100A, 100B. In other words, the connector device 10, 10A, 10B should be configured so that one of the guide portion 260, 260A, 260B and the mating guide portion 560 is the guide protrusion 570 while a remaining one of the guide portion 260, 260A, 260B and the mating guide portion 560 is the guide ditch 260, 260A, 260B which receives the guide protrusion 570 to guide the rotational movement of the connector 100, 100A, 100B.

Although the connector devices 10, 10A, 10B of the present embodiment and modifications are configured so that the guide protrusion 570, which is provided on the mating housing 500, functions as the mating maintenance portion 540 while the maintenance portion 240, 240A, 240B is provided in the guide ditch 260, 260A, 260B which is provided on the housing 200, 200A, 200B, the present invention is not limited thereto. Specifically, the connector device 10, 10A, 10B may be configured so that the guide protrusion 570, which is provided on the housing 200, 200A, 200B, functions as the maintenance portion 240, 240A, 240B while the mating maintenance portion 540 is provided in the guide ditch 260, 260A, 260B which is provided on the mating housing 500. In other words, the connector device 10, 10A, 10B should be configured so that, if the guide protrusion 570 also functions as one of the maintenance portion 240, 240A, 240B and the mating maintenance portion 540, a remaining one of the maintenance portion 240, 240A, 240B and the mating maintenance portion 540 is provided in the guide ditch 260, 260A, 260B.

Although the connector devices 10, 10A, 10B of the present embodiment and modifications are configured so that the guide protrusion 570 functions as both the mating maintenance portion 540 and the mating guide portion 560 while the maintenance portion 240, 240A, 240B is provided in the guide ditch 260, 260A, 260B which is the guide portion 260, 260A, 260B, the present invention is not limited thereto. For example, the connector device 10, 10A, 10B may be configured as follows: the mating maintenance portion 540 is a protrusion which is distinct and separated from the guide protrusion 570 and which is provided on the mating housing 500; and the maintenance portion 240, 240A, 240B is a recess or hole which is distinct and separated from the guide portion 260, 260A, 260B and which is provided on the housing 200, 200A, 200B. Alternatively, the connector device 10, 10A, 10B may be configured so that the mating maintenance portion 540 and the maintenance portion 240, 240A, 240B are the reverse of the configuration as described above. In short, the connector device 10, 10A, 10B may be configured so that the mating maintenance portion 540 is provided so as to be distinct and separated from the guide protrusion 570 while the maintenance portion 240, 240A, 240B is provided so as to be distinct and separated from the guide portion 260, 260A, 260B. However, the housing 200, 200A, 200B and the mating housing 500 of the connector devices 10, 10A, 10B of the present embodiment and modifications are easily formed because the connector devices 10, 10A, 10B of the present embodiment and modifications are configured so that the guide protrusion 570 also functions as the mating maintenance portion 540 while the part of the guide portion 260, 260A, 260B also functions as the maintenance portion 240, 240A, 240B. Accordingly, the connector devices 10, 10A, 10B of the present embodiment and modifications are more preferable.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector device comprising a connector and a mating connector, wherein:
the connector and the mating connector are mateable with each other;
the connector comprises a housing and a terminal;
the housing holds the terminal;
the housing is provided with an axis portion and a maintenance portion;
the mating connector comprises a mating housing and a mating terminal;
the mating housing holds the mating terminal;
the mating housing is provided with a mating axis portion and a mating maintenance portion;
one of the axis portion and the mating axis portion is a rotation axis with an axis direction;
a remaining one of the axis portion and the mating axis portion is a bearing;
the connector is rotatable around the rotation axis between an open position and a close position when the axis portion and the mating axis portion are combined with each other;
the terminal is not connected with the mating terminal when the connector is positioned at the open position;
the terminal is connected with the mating terminal when the connector is positioned at the close position; and
the maintenance portion and the mating maintenance portion temporarily maintain a position of the connector at the open position.

2. The connector device as recited in claim 1, wherein:
the housing is further provided with a guide portion;
the mating housing is further provided with a mating guide portion;
one of the guide portion and the mating guide portion is a guide protrusion;
a remaining one of the guide portion and the mating guide portion is a guide ditch which receives the guide protrusion to guide a rotational movement of the connector; and
if the guide protrusion also functions as one of the maintenance portion and the mating maintenance portion, a remaining one of the maintenance portion and the mating maintenance portion is provided in the guide ditch.

3. The connector device as recited in claim 2, wherein:
the guide protrusion functions as both the mating guide portion and the mating maintenance portion;
the guide portion is the guide ditch;
the guide protrusion is positioned at a first position in the guide ditch when the connector is positioned at the open position;
the guide protrusion is positioned at a second position in the guide ditch when the connector is positioned at the close position; and
the maintenance portion is provided in the guide ditch at a location which is positioned beyond the first position in an orientation from the first position toward the second position.

4. The connector device as recited in claim 3, wherein:
the guide ditch has a bottom surface; and
the maintenance portion is bulged from the bottom surface in the guide ditch.

5. The connector device as recited in claim 3, wherein:
the guide protrusion has a diameter; and
the maintenance portion has a width which is less than the diameter of the guide protrusion.

6. The connector device as recited in claim 1, wherein:
the axis portion is the bearing;
when the connector is positioned at the open position, the axis portion is opened downward in an up-down direction perpendicular to the axis direction of the rotation axis;
the mating axis portion is the rotation axis;
the mating axis portion is lightly press-fit into the bearing; and
when the connector is positioned at the open position, the connector is separable from the mating connector by the connector being moved upward in the up-down direction.
